(19) United States
(12) Patent Application Publication
(10) Pub. No.: US 2016/0006273 A1
(43) Pub. Date: Jan. 7, 2016

(54) METHOD AND APPARATUS FOR REDUCING CHARGE TIME

(71) Applicant: Texas Instruments Incorporated, Dallas, TX (US)

(72) Inventors: Byron Mitchell Reed, Murphy, TX (US); Miguel Aguirre, McKinney, TX (US); Will Hadden, Murphy, TX (US)

(21) Appl. No.: 14/324,202

(22) Filed: Jul. 6, 2014

(51) Int. Cl. H02J 7/00

(52) U.S. Cl. CPC H02J 7/007; H02J 7/0052

(57) ABSTRACT

A method, an apparatus and a system for reducing charge time. The method includes determining a current is below a current threshold and a voltage is below a voltage threshold, and based on the determination, terminating an adapter from charging a charge cell.

### BACKGROUND OF THE INVENTION

1. Field of the Invention

Embodiments of the present invention generally relate to a method and apparatus for reducing charge time.

2. Description of the Related Art

It is desirable for a device to have a short charge time, for example, battery charge time. It is also desirable to maximize power delivered from an adapter, which may reduce battery charge time. When an adapter is heavily loaded, its output voltage drops. A significant drop in voltage is utilized to determine when the adapter is either removed or is not supplying desired charge. However, despite such a voltage drop, the adapter may be operating within valid operating conditions. Thus, using the voltage drop as the sole indicator for such a determination is misleading.

Therefore, there is a need for a method and/or apparatus for determining that the adapter is not functioning within a valid operating condition.

### SUMMARY OF THE INVENTION

Embodiments of the present invention relate to a method, an apparatus and a system for reducing charge time. The method includes determining a current is below a current threshold and a voltage is below a voltage threshold, and based on the determination, terminating an adapter from charging a charge cell.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of an apparatus for reducing charge time;

FIG. 2 is an embodiment of a flow diagram depicting a method for reducing charge time;

FIG. 3 is another embodiment of a flow diagram depicting a method for reducing charge time; and

FIG. 4 is an embodiment of a block diagram depicting a system for reducing charge time.

### DETAILED DESCRIPTION

Described herein is an embodiment for reducing charge time. More specifically, described herein is an apparatus and a method of detecting an adapter is not functioning within valid conditions.

For example, when an adapter is heavily loaded its output voltage will drop. In some embodiment, a voltage drop is determined using a threshold, for example, ˜100 mV of the battery. If the voltage drops below the threshold, the adapter is determined to have been removed or cannot supply the desired current. Charge may then be terminated or may enter SLEEP mode. In one embodiment, the adapter is set to adapter removed mode.

However, such an approach is misleading because despite the drop in voltage below the threshold, the adapter may be functioning within valid conditions. For example, there could be a case where 100 mV is a valid operating condition for the adapter.

Hence, proposed herein is an embodiment that utilizes both a voltage and a current threshold to detect an adapter functioning within invalid conditions. In such an embodiment, when both the voltage and current threshold are met, the charge is then terminated, enter SLEEP mode, etc. For example SN2400 (Tigris) requires the input voltage drops to within 100 mV of the battery and the input current drops below 50 mA before indicating adapter removal or SLEEP mode.

Hence, a second condition which measures the input current before indicating adapter removal resolves the adapter removal problem. In such an embodiment, the current threshold is in addition to the voltage threshold.

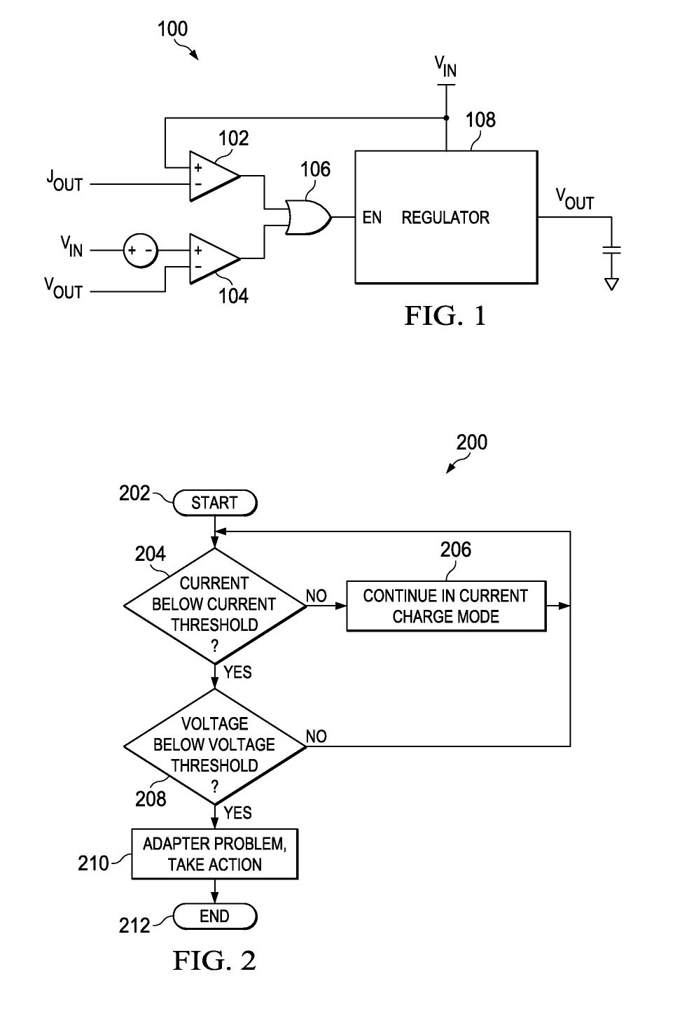

FIG. 1 is an embodiment of an apparatus 100 for reducing charge time, for example, battery charge time. The apparatus 100 includes a current comparator 102, a voltage comparator 104, an OR gate 106 and a regulator 108. The current comparator 102, coupled to the OR gate 106, determines if the current is below a current threshold. The current comparator 102 is shown in FIG. 1 to be an amplifier; however, any current comparator may be utilized to determine the relationship between an input current and a current threshold. The voltage comparator 104, coupled to the OR gate 106, determines if the input voltage dropped below a voltage threshold. The voltage comparator 104 is shown in FIG. 1 to be an amplifier; however, any voltage comparator may be utilized to determine the relationship between an input voltage and a voltage threshold. If either is true, the OR gate 106 is set high. The OR gate 106 is coupled to the regulator 108. In one embodiment, the regulator 108 is enabled if either the input voltage is above some threshold or the input current is above some threshold, the regulator is disabled if both conditions are false. In another embodiment, such a regulator may not be utilized. The apparatus 100 performs operations, such as, method 200 and method 300, described herein below.

FIG. 2 is an embodiment of a flow diagram depicting a method 200 for reducing charge time, for example, battery charge time. The method 200 starts at step 202 and proceeds to step 204. At step 204, the method 200 determines if the current is below a current threshold. If the current is below a threshold, the method 200 proceeds to step 208; otherwise, the method 200 proceeds to step 206. At step 206, the method 200 continues its current charge mode and returns to step 204. At step 208, the method 200 determines if the voltage is below a voltage threshold. If the voltage is below a threshold, the method 200 proceeds to step 210; otherwise, the method 200 returns to step 204. At step 210, the method 200 determines that the adapter is experiencing trouble and the method 200 takes the relevant action, for example, disconnect the adapter, set a system/device to SLEEP mode, etc. From step 210, the method 200 proceeds to step 212. The method 200 ends at step 212.

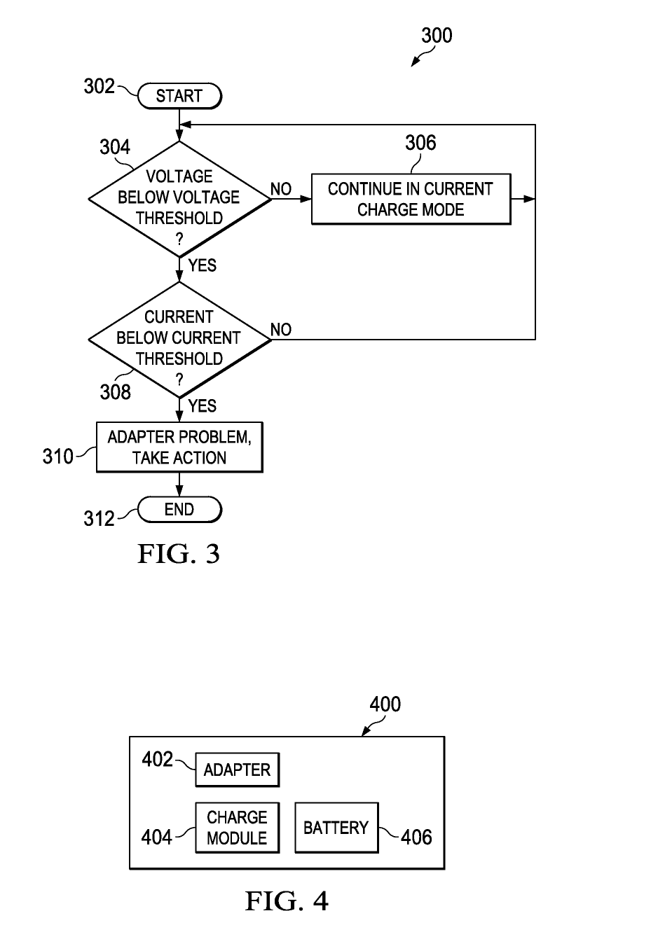

FIG. 3 is another embodiment of a flow diagram depicting a method 300 for reducing charge time, for example, battery charge time. The method 300 starts at step 302 and proceeds to step 304. At step 304, the method 300 determines if the voltage is below a voltage threshold. If the voltage is below a threshold, the method 300 proceeds to step 308; otherwise, the method 300 proceeds to step 306. At step 306, the method 300 continues its current charge mode and returns to step 304. At step 308, the method 300 determines if the current is below a current threshold. If the current is below a threshold, the method 300 proceeds to step 310; otherwise, the method 300 returns to step 304. At step 310, the method 300 determines that the adapter is experiencing trouble and the method 300 takes the relevant action, for example, disconnect the adapter, set a system/device to SLEEP mode, etc. From step 310, the method 300 proceeds to step 312. The method 300 ends at step 312.

FIG. 4 is an embodiment of a block diagram depicting a system 400 for reducing charge time. The system 400 includes an adaptor 402, a charge module 404, and a charge cell 406. The adapter 402 provides charge to the charge cell 410. The charge module 404 performs a method for reducing charge time, for example, method 200 of FIG. 2 and method 300 of FIG. 3. The charge cell is any source that provides charge to a device, such as, a battery, charge cell, etc.

While the foregoing is directed to embodiments of the present invention, other and further embodiments of the invention may be devised without departing from the basic scope thereof, and the scope thereof is determined by the claims that follow.

What is claimed is:

1. A method of a charge module, comprising:
determining a current is below a current threshold and a voltage is below a voltage threshold;
based on the determination, terminating an adapter from charging a charge cell.

2. The method of claim 1, wherein the termination comprises at least one of disconnecting an adapter charging the charge cell and set mode to at least one of sleep mode or adapter removed.

3. An apparatus for reducing charge time, comprising:
a current comparator;
a voltage comparator;
an AND gate coupled to the current comparator and the voltage comparator, wherein the AND gate allows for charging a charge cell when both the current comparator and the voltage comparator determine that the current is above a current threshold and the voltage is above a voltage threshold.

4. The apparatus of claim 3 further comprising a regulator coupled to the AND gate.

5. A system for reducing charge time, comprising:
an adapter;
a charge cell;
a charge module, where the charge module is coupled to the adapter and the charge cell, and wherein the charge module terminates the adapter charging the charge cell when the current is below a current threshold and the voltage is below a voltage threshold.
